(19) United States
(12) Patent Application Publication
(10) Pub. No.: US 2015/0111336 A1
(43) Pub. Date: Apr. 23, 2015

(54) PHOTOVOLTAIC DEVICE AND METHOD OF MANUFACTURE

(71) Applicant: SWANSEA UNIVERSITY, Swansea (GB)

(72) Inventors: Trystan Watson, Swansea (GB); David Worsley, Swansea (GB); Cecile Charbonneau, Swansea (GB)

(73) Assignee: SWANSEA UNIVERSITY, Swansea (GB)

(21) Appl. No.: 14/391,452

(22) PCT Filed: Apr. 9, 2013
(86) PCT No.: PCT/GB2013/000164

§ 371 Date: Oct. 9, 2014

(30) Foreign Application Priority Data
Apr. 11, 2012 (GB) 1206388.9

(51) Int. Cl. H01G 9/00; H01G 9/20

(52) U.S. Cl. CPC H01G 9/0029; H01G 9/2022
USPC 438/98

(57) ABSTRACT

A counter electrode generally shown as 1 is formed of a conductive substrate e.g. a glass substrate 10 on which is deposited doped oxide, e.g. a fluorine doped tin oxide 20. Overlaying the fluorine layer is a layer of a metal halide, e.g. platinum chloride 30 (5 Mm H₂PtCl₆(H₂O₆) in isoproply alcohol. Metal is deposited from the solution by treating with NIR. The tin oxide layer renders the glass electrically conductive, absorbs significantly in the NIR and allows for the subsequent heating of the Pt—Cl via a heat transfer process to make the counter electrode in a very efficient manner.

### FIELD OF THE INVENTION

The invention relates to a photovoltaic device and a method of manufacture. In particular but not exclusively the device is a counter electrode for use in a dye sensitised solar cell (DSC)

### BACKGROUND OF THE INVENTION

Dye sensitised solar cells (DSCs) typically consist of a working electrode and a counter electrode. The working electrode comprises a conductive substrate coated with a semi-conductive nanoparticulate metal oxide and a dye adsorbed onto the metal oxide to sensitize it to a larger portion of the solar spectrum. The counter electrode comprises a conductive layer and a catalytic material such as platinum deposited onto the conductive layer. The working electrode and the counter electrode may then be bonded together using sealants and spacers to form a well-defined space in which an electrolyte is housed.

The electrolyte is usually an iodine/iodide redox couple in an organic solvent. A critical step in the manufacture of such DSCs is the deposition of the nanoparticulate metal oxide onto a conductive substrate of the working electrode such as glass or a metal substrate which is typically titanium and exposing it to high temperatures. In known systems, the metal oxide, which is often a paste, is then subjected to a heat treatment to remove the solvent and the binder from the paste leaving behind a mesoporous metal oxide layer on top of the conductive substrate. If high enough temperatures are provided, sintering of the metal oxide occurs, which increases the number of interconnections between metal oxide particles (“necking”) and consequently the electrical conductivity of the metal oxide. The heating is by way of a convection oven which is costly as the oven needs to be brought up to temperature and also it is also a lengthy process as typically the heat treatment is 30 minutes or more.

Roll to roll processing of plastic electronics, including photovoltaics, is currently an area attracting a great deal of attention. The printing of sensors and electrodes is becoming a more important way of manufacturing devices and because of the high throughput of these printing techniques, any lengthy thermal processes, especially those that slow down production is not desirable.

The present invention seeks to overcome the problems associated with the prior art by providing a method of forming an electrode, and in particular a counter electrode, that avoids the need for lengthy heating using a convection oven so that an electrode can be produced by a method that is rapid and a cost efficient process.

### SUMMARY OF THE INVENTION

According to a first aspect of the invention there is provided a method of manufacturing a counter electrode for use in a dye sensitised solar cell including the consecutive steps of:
providing a conductive substrate having a first side and a second side;
a depositing a platinum group metal halide in solution on a first side of the conductive substrate; and
exposing the first side of the conductive substrate to near-infrared radiation at a wavelength of between 700 and 2500 nm to allow metal from the platinum group metal halide to be deposited on the substrate.

It is envisaged that after heating with NIR, the conductive substrate is allowed to cool so that metal is deposited on the substrate. The cooling stage allows for ease of handling of the substrate on which the metal has been deposited from the solution.

It is preferred that the conductive substrate is an electrochemically inert material selected from glass, or plastic, if plastic is used, preferred plastics are PET (polyethylene terephthalate) or PEN (polyethylene napthalate. The glass or plastic will have been doped on the first side with a conductive material, for example in the case of glass, fluorine doped tin oxide forms the transparent conductive oxide (TCO). If plastic is used the doping is generally by way of indium tin oxide however the doping materials that are used may be interchanged.

When treating with NIR, it is preferable to direct the NIR to the side of the substrate having the TCO to avoid absorption of the MR by the conductive substrate, which may be a layer such as glass that is thicker than the doped layer.

Alternatively the conductive substrate is a metal substrate, preferably titanium or stainless steel or mild steel or electro-coated chromium steel (ECCS) or mild steel having a zinc or zinc based coating or molybdenum tungsten or nickel. These materials are useful in that they have all demonstrated a degree of corrosion resistance to the electrolyte.

It is envisaged that the metal substrate can be shaped deformed.

Preferably the platinum group metal halide is provided in solution in the form of an acid. The platinum group metal halide which is provided forms an electrocatalyst in a soluble form.

Preferably the acid is chloroplatinic acid.

It is preferred that the solution for the platinum group metal halogen is an aqueous solution or an alcohol.

It is envisaged that the aqueous solution or alcohol is selected from ethanol, or water, or ethanol and water, or isopropylalcohol (IPA).

It may be that the solution for the platinum group metal halide may optionally include a binder.

Preferably the binder is polyethylene glycol or ethyl cellulose. The binders can be used in screen printable pastes so that the platinum group metal halide can be deposited on a surface by a printing method. Other printing methods include gravure printing, coil coating or a doctor blade method. Advantageously, both binders are easily accessible, inexpensive and have low boiling points.

It is preferred that the exposure to NIR is performed in 5 to 50 seconds and more preferably in 5 to 25 seconds.

It is envisaged that the NIR is at a wavelength of 800 to 1200 nm, more preferably 900 to 1000 nm.

According to a second aspect of the invention there is provided a solar cell comprising a counter electrode according to a first aspect of the invention and a working electrode having a conductive substrate coated with a metal oxide and a dye adsorbed onto the metal oxide, the counter electrode and working electrode being on connected with an electrolyte being positioned between the two electrodes.

The present invention allows for the manufacture of a counter electrode by a much more efficient method. Advantageously, these shorter time-scales will improve the throughput potential of the manufacturing process and contribute greatly to the scaling potential of the technology. Importantly, the method according to the invention is still able to remove the solvent and break bonds in the metal halogen so metal can be deposited over a much shorter time period compared to the state-of-the-art, i.e., in seconds rather than many minutes.

### BRIEF DESCRIPTION OF THE DRAWINGS

An embodiment of the present invention will now be described by way of example only, with references to and as illustrated in the accompanying figures in which:

FIG. 1 shows: a counter electrode according to a an embodiment of the invention;

FIG. 2 shows: the spectral range used for the output of the MR device;

FIG. 3 shows: a solar cell having a counter electrode according to an embodiment as shown in FIG. 1.

### DETAILED DESCRIPTION OF THE INVENTION

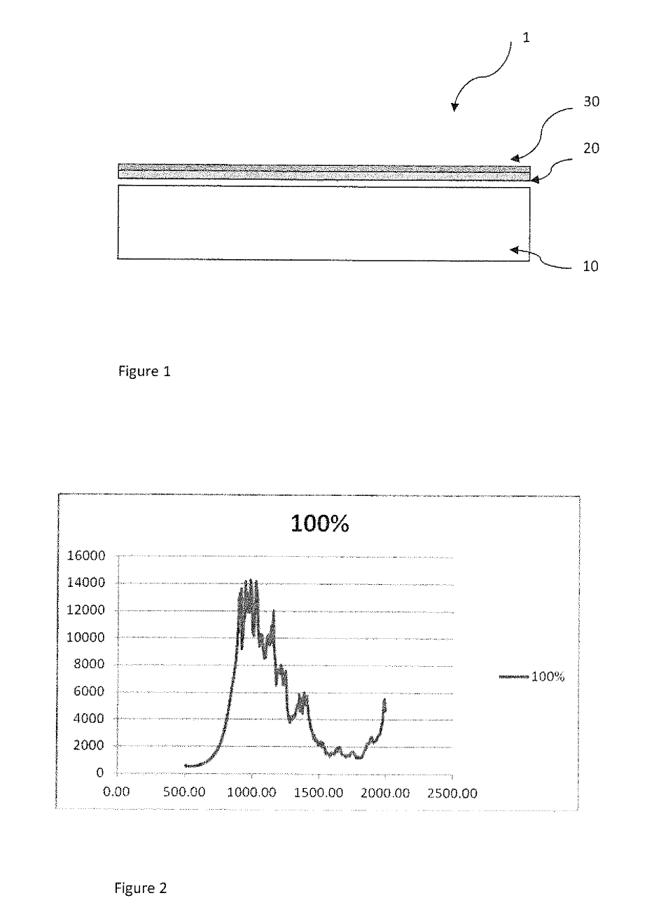

FIG. 1 shows an electrode 1 according to an embodiment of the invention. The electrode is formed of a glass substrate 10 on which is deposited a fluorine doped tin oxide 20. Overlaying the fluorine doped tin oxide layer is a layer of chloroplatinic acid 30 (5 Mm H₂PtCl₆(H₂O)₆)in iso proply alcohol which enables the layer to flow across the fluorine doped layer such as fluorine doped tin oxide. The flourine doped tin oxide layer, which renders the glass electrically conductive, absorbs significantly in the NIR and this allows for the subsequent heating of the Pt—Cl via a heat transfer process.

The platinum chloride layer was then treated with near infra-red radiation with a wavelength of 800 to 1500 nm and preferably 800 nm to 1000 nm. Although the layer includes platinum it is envisaged that other platinum group metals such as nickel or palladium may be used.

As shown in FIG. 2, the radiation is in the NIR spectrum and not the visible spectrum. The use of electromagnetic radiation enables the substrate to be heated rapidly and much faster than when using a convection oven. In general, the use of shorter wavelengths, i.e., 800 to 1000 nm, increases the rate in which the substrate is heated due to shorter wavelengths having higher energy. In another embodiment of the invention the electromagnetic radiation has a peak intensity in the range of 800 nm to 1000 nm, or 900 nm to 950 nm and preferably 910 nm to 930 nm. By using electromagnetic radiation with a peak intensity in the range of 910-930 nm the heat treatment is optimised since the electromagnetic radiation is largely unabsorbed by components in which the metal halide is carried such as the solvent and the binder. Therefore, the substrate should absorb the maximum amount of radiation available, which allows for a rapid transition of chloroplatinic acid to nano platinum.

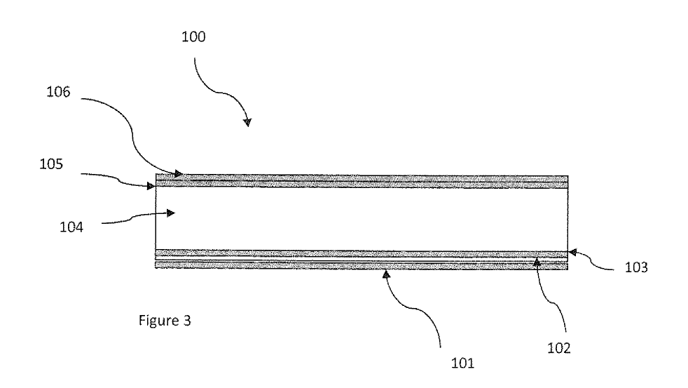

FIG. 3 shows a solar cell which is generally shown as 100 in the figure and it includes a counter electrode according to the embodiment shown in FIG. 1.

The cell includes a conductive substrate 101 which may be a metal or glass with transparent conductive oxide (TCO) or it could be a plastic with TCO. This substrate will form the basis of the working electrode. Metal substrates may be surface modified whilst maintaining the desirable bulk properties of the metal substrate. For example, metal substrates may be surface modified with a protective conductive coating by printing, sputter deposition, plasma deposition, chemical vapour deposition (CVD) or physical vapour deposition (PVD) processes, sol-gel, electrochemical (masking) deposition processes or lamination. Metal substrates absorb electromagnetic radiation and are excellent conductors of heat. Titanium possesses an excellent strength to weight ratio and excellent corrosion resistance to the electrolyte, for this reason it is not necessary to provide titanium substrates with a protective conductive coating. Not having to provide a coating has the added benefit that expenditure may be reduced since there is one less process step. In addition, titanium is formable and is able to absorb electromagnetic radiation and conduct heat efficiently.

Stainless steel substrates exhibit good corrosion resistance to the electrolyte and reflect photons back towards the dye sensitised metal oxide layer by virtue of its mirrored finish, thus it is expected that DSC efficiency will increase when using such substrates. Stainless steel substrates are have good electromagnetic absorption, good heat conduction properties and are less expensive than titanium substrates.

Mild steel substrates offer yet another alternative to both titanium and stainless steel substrates due to their low material cost, However, despite being formable and absorbing electromagnetic radiation and conducting heat efficiently, mild steel substrates can rust and do not possess good corrosion resistance to the electrolyte.

If glass is used the glass has a doped layer such fluorine doped tin oxide on glass or indium tin oxide, which also may be provided on a plastic (e.g. PET or PEN) rather than glass.

There is then a layer 102 which is typically a paste comprising a metal oxide such as TiO2, a binder and a solvent so that the oxide can be printed on a surface. The metal may also be a wide band gap metal oxide such as SnO2 or ZnO or TiO2. An advantage of SnO2 is that it is easier to obtain good particle interconnectivity which will minimise resistive losses and increase the efficiency of the DSC. An advantage of using ZnO is that ZnO nanoparticles are readily available at low material cost. In addition, it is expected that the use of ZnO ordered one dimensional structures such as rods, wires combs and alike may improve DSC efficiency, such structures are currently difficult to grow using metal oxides. There are however, several advantages are associated with using TiO2, namely, TiO2 is readily available, cheap, none-toxic and possesses good stability under visible radiation in solution, and an extremely high surface area suitable for dye adsorption. TiO2 is also porous enough to allow good penetration by the electrolyte ions, which is essential for effective dye regeneration. Finally, TiO2 scatters incident photons effectively to increase light harvesting efficiency. Typically the dry film thickness of the metal oxide is between 3 microns and 50 microns, preferably between 5 microns and 25 microns and more preferably between 8 microns and 12 microns. The dry film thickness of a film may be defined as the thickness of the film after the solvent and the binder.

The next layer 103 is a dye and then there is an electrolyte layer 104 which may be an iodine electrolyte.

The next layer 105 is the counter electrode 105 which is provided as a substrate, which again may be a metal or in particular a glass substrate which again can be fluorine doped tin oxide on glass or indium tin oxide on a plastic such as PET or PEN. The counter electrode is a substrate on which a metal from a platinum group metal halide solution has been deposited. The NIR processing allows for the direct deposition from solution of a platinum group metal such as platinum or palladium. The counter electrode can be formed from substrate such as glass, plastic or metal so long as the material used is conducting (either through inherent properties in the case of metals or if it is doped, for example in the case of glass or plastic) and is inert to the electrolyte

There a number of different forms of architecture for the electrodes. Both the working and the counter electrodes cannot be opaque as light is needed to activate the DSC cell so either the working or the counter electrode needs to be transparent. If the working electrode is transparent the counter electrode can be a metal, for example titanium, stainless steel, molybdenum, tungsten or nickel.

The classic architecture is that both electrodes are FTO glass. A second architecture, that is less used than the first is a titanium working electrode and a transparent glass or plastic counter electrode. The third possible architecture (but less likely) would be a titanium counter electrode (with Pt) and an FTO glass or ITO plastic working electrode. In terms of the terminology used, the counter electrode is the electrode that is platinised while the working electrode is one including TiO₂.

In the case of the counter electrode there is a consistent spread of deposited metal across the surface of a conductive substrate support. The use of an alcohol allows for spread of the metal halogen across the surface of the substrate and also the carrier, which is typically a solvent. The above solvents are relatively low boiling point solvents that can be easily removed from the solution or if the process involves screen printing, at low temperatures. If a binder is used, typically it is polyethylene glycol or ethyl cellulose.

To lay down the metal on the substrate the conductive substrate is heated on its first side although it may be heated on its second side using NIR. By heating the substrate on its second side the speed in which the substrate is heated may increase since the substrate is able to absorb the maximum amount of radiation available. However, an advantage of heating the substrate on its first side is that the first side of the substrate, which is in direct contact with the metal halide in solution is that the chemicals will be in direct contact with the radiation applied and this will allow for heating up of the chemicals at a slightly faster rate than the bulk because it is closer to the radiation source. Therefore, heat should be transferred to the chemical at an increased rate and consequently it should take less time to remove the solvent and the binder from the paste and for a metal to be deposited on the substrate.

If a polymer such as PET (Polyethylene terephthalate)or PEN (polyethylene napthalate) is used as the substrate for the counter electrode the power output of NIR lamps were adjusted to prevent damage to the PET substrate. Over exposure to heat can cause undesirable buckling of the PET film rendering it unusable. The near-infrared region (NIR) of the electromagnetic spectrum is situated between the visible and the infrared at a wavelength of 700 nm to 2500 nm with a peak at around 1000 nm where typically polymer compounds do not have a strong absorbance. In particular the power and wavelength used is involved in the kinetics of the breaking of the Pt—Cl bonds in the platinum metal halide solution, which will occur more slowly at lower temperatures. For the plastic substrates we can achieve some performance from repeatedly passing it under the NIR lamp at lower power settings though it doesn't perform the same as the FTO glass.

The final layer 106 is a protective layer such as glass which also has conductivity.

Although the foregoing invention has been described in some detail by way of illustration and example, and with regard to one or more embodiments, for the purposes of clarity of understanding, it is readily apparent to those of ordinary skill in the art in light of the teachings of this invention that certain changes, variations and modifications may be made thereto without departing from the scope of the invention as described in the appended claims. Furthermore the invention is intended to cover not only individual embodiments that have been described but also combinations of the described embodiments.

1. A method of manufacturing a counter electrode for use in a dye sensitised solar cell including the consecutive steps of:
providing a conductive substrate having a first side and a second side;
depositing a platinum group metal halide in solution on a first side of the conductive substrate; and
exposing the first side of the conductive substrate to near infrared radiation at a wavelength of between 700 and 2500 nm to allow metal from the platinum group metal halide to be deposited on the substrate.

2. A method according to claim 1 wherein the platinum group metal halide is a chosen one of platinum and palladium.

3. A method according to claim 1 wherein the conductive substrate is an electrochemically inert material selected from the group consisting of: glass and plastic.

4. A method according to claim 1 3 wherein the conductive substrate is a metal substrate, selected from the group consisting of: titanium, molybdenum, tungsten, nickel, stainless steel, mild steel, electro-coated chromium steel (ECCS), and mild steel having a zinc or zinc based coating thereon.

5. A method according to claim 4, wherein the metal substrate can be shaped deformed.

6. A method according to claim 1 wherein the platinum group metal halide is provided in solution in the form of an acid.

7. A method according to claim 6, wherein the acid is chloroplatinic acid.

8. A method according to claim 1 wherein the solution for the metal halogen is a chosen one of an aqueous solution, an alcohol, and an alcohol in an aqueous solution.

9. A method according to claim 8, wherein when the solution contains an alcohol, the alcohol is selected from ethanol, propanol, and isopropylalcohol.

10. A method according to claim 1 wherein the solution for the platinum group metal halide includes a binder.

11. A method according to claim 10, wherein the binder is a chosen one of polyethylene glycol and ethyl cellulose.

12. A method according to claim 1 wherein the metal halide in solution is deposited on the substrate by printing.

13. A method according to claim 1 wherein the near-infrared radiation is applied for a period of 5 to 50 seconds.

14. A method according to claim 1 wherein the near-infrared radiation is at a wavelength of 800 to 1200 nm.

15. A method according to claim 1 wherein the first side of the conductive substrate is exposed to near-infrared radiation a chosen of at the same time as, and followed by, exposure of the second side of the conductive substrate to NIR radiation.

16-17. (canceled)

18. A method according to claim 1 wherein the metal halide in solution is deposited on the substrate by screen printing.

19. A method according to claim 1 wherein the near-infrared radiation is applied for a period of 5 to 25 seconds.

20. A method according to claim 1 wherein the near-infrared radiation is at a wavelength of 900 to 1000 nm.
